(19) United States
(12) Patent Application Publication
(10) Pub. No.: US 2025/0150931 A1
(43) Pub. Date: May 8, 2025

(54) MAINTAINING MULTI-PATH LINKS IN SIDELINK SCENARIOS DURING HANDOVER

(71) Applicant: Telefonaktiebolaget LM Ericsson (publ), Stockholm (SE)

(72) Inventor: Antonino ORSINO, KIRKKONUMMI (FI)

(73) Assignee: Telefonaktiebolaget LM Ericsson (publ), Stockholm (SE)

(21) Appl. No.: 18/837,800

(22) PCT Filed: Feb. 27, 2023
(86) PCT No.: PCT/EP2023/054833

§ 371 Date: Aug. 12, 2024

Related U.S. Application Data
(60) Provisional application No. 63/314,248, filed on Feb. 25, 2022.

(51) Int. Cl. H04W 40/18; H04L 45/24; H04W 36/30; H04W 76/28; H04W 88/04

(52) U.S. Cl. CPC H04W 40/18; H04L 45/24; H04W 36/305; H04W 76/28; H04W 88/04

(57) ABSTRACT

The invention refers to a method performed by a wireless device, remote UE (10), wherein the remote UE (10) is connected to a cell established by a base station, gNB (50), wherein the UE performs the steps of: maintaining a first and a second communication path, wherein each the first and the second communication path is either a direct path (110), where the communication is exchanged directly between the remote UE and the gNB, or an indirect path (120, 130), wherein the communication is exchanged between the UE and the gNB via a relay UE (20, 30); determining that one of communication paths becomes or will become unavailable; and activating a third communication path (140, 150) to replace the communication paths that becomes or will become unavailable; the invention further refers to corresponding methods in a relay UE and in a gNB, and to corresponding devices comprising the remote UE, the relay UE and the gNB.

### TECHNICAL FIELD

The present application relates generally to the field of sidelink communication, and specifically relates to service continuity in sidelink communication.

### BACKGROUND

5G is the fifth generation of mobile communications, addressing a wide range of use cases from enhanced mobile broadband (eMBB) to ultra-reliable low-latency communications (URLLC) to massive machine type communications (mMTC) and sidelink. 5G includes the New Radio (NR) access stratum interface and the 5G Core Network (5GC). The NR physical and higher layers are reusing parts of the LTE specifications by adapting LTE specifications and creating new specifications, if needed.

Sidelink communications are communications directly between communication devices (user equipment, or UEs). From Releases 12 to Release 15 of the 3GPP standard, sidelink transmissions are designed based on the air interface of LTE-A. In Release 16, NR Sidelink transmissions are specified by inheriting some parts of concepts from LTE-A. A new introduction to the physical layer structure of NR is provided. Furthermore, enhancements to public safety, relay, etc are planned in 3GPP.

In particular, a layer-2 (L2) based UE-to-Network relay is described in clause 6.7 of 3GPP document TR 23.752 (current version 17.0.0). The L2 UE-to-Network Relay UE (or simply, Relay UE) provides forwarding functionality that can relay any type of traffic over a link, also being referred to as PC5 link, between the Remote UE and the Relay UE. Accordingly, the L2 UE-to-Network Relay UE provides functionality to support connectivity to the 5G communication system (5GS) for Remote UEs. A UE is considered to be a Remote UE, if it has successfully established a PC5 link to the relay UE (L2 UE-to-Network Relay UE). A Remote UE can be located within cell (NG-RAN) coverage or outside of cell (NG-RAN) coverage.

FIG. 1 illustrates the protocol stack for the user plane transport, related to a PDU Session, including a L2 UE-to-Network Relay UE. The PDU layer corresponds to the PDU carried between the Remote UE and the Data Network (DN) over the PDU session. The PDU layer corresponds to the PDU carried between the Remote UE and the Data Network (DN) over the PDU session. It is important to note that the two endpoints of the PDCP link are the Remote UE and the gNB. The relay function is performed at a layer in the protocol stack below the PDCP layer. This means that data security is ensured between the Remote UE and the gNB without exposing raw data at the UE-to-Network Relay UE.

Still referring to FIG. 1, the adaptation realy layer within the UE-to-Network Relay UE can differentiate between signalling radio bearers (SRBs) and data radio bearers (DRBs) for a particular Remote UE. The adaption relay layer is also responsible for mapping PC5 traffic to one or more DRBs of the Uu interface between the Relay UE and the radio access network (RAN). The definition of the adaptation relay layer is under the responsibility of RAN WG2.

FIG. 2 illustrates the protocol stack of the non-access stratum (NAS) connection of the Remote UE to the NAS mobility management (NAS-MM) and NAS session management (NAS-SM) components as e.g. described in TR 23.752. The NAS messages are transparently transferred between the Remote UE and NG-RAN over the Layer 2 UE-to-Network Relay UE using a PDCP end-to-end connection, where the role of the UE-to-Network Relay UE is to relay the PDUs over the signalling radio bear without any modifications, an N2 connection between the NG-RAN and AMF over N2 and a connection to AMF and SMF over N11. The role of the UE-to-Network Relay UE is to relay the PDUs from the signaling radio bearer without any modifications.

The L2 UE-to-Network Relay uses the RAN2 principle of the Rel-15 NR handover procedure as the baseline access stratum (AS) layer solution to guarantee service continuity. That is, the gNB hands over the Remote UE to a target cell or target Relay UE. This operation includes a handover preparation-type of procedure between the gNB and the Relay UE (if needed). The gNB sends a RRCReconfiguration message to the Remote UE, causing the Remote UE to switch to the target. Upon successful switchover, the Remote UE sends a handover complete message to the gNB in a manner similar to the legacy procedure.

Some common parts of intra-gNB cases and inter-gNB cases are described below. For the inter-gNB cases, compared to the intra-gNB cases, potential different parts on RAN2 Uu interface will be determined by the standards committee.

In the following, two scenarios for service continuity according to 3GPP TR 38.836, (current version 17.0.0) section 4.5.4 are being described:

FIG. 3 illustrates a switching from indirect to direct path (remote UE switching from being connected through a Relay UE to being connected directly to the Uu cell):
1. The Uu measurement configuration and measurement report signalling procedures is performed to evaluate both relay link measurement and Uu link measurement. The measurement results from U2N Remote UE are reported when configured reporting criteria is met. The SL relay measurement report shall include at least U2N Relay UE ID, serving cell ID, and SL-RSRP information.
2. The gNB decides to switch the Remote UE onto direct Uu path.
3. The gNB sends RRCReconfiguration message to the U2N Remote UE. The U2N Remote UE stops UP and CP transmission via U2N Relay UE after reception of RRCReconfiguration message from the gNB.
4. The U2N Remote UE synchronizes with the gNB and performs Random Access.
5. The UE (i.e. previous U2N Remote UE) sends the RRCReconfigurationComplete to the gNB via target path, using the configuration provided in the RRCReconfiguration message. From this step, the U2N Remote UE moves the RRC connection to the gNB
6. The gNB sends RRCReconfiguration message to the U2N Relay UE to reconfigure the connection between the U2N Relay UE and the gNB. The RRCReconfiguration message to the U2N Relay UE can be sent any time after step 3 based on gNB implementation (e.g. to release Uu and PC5 RLC configuration for relaying, and bearer mapping configuration between PC5 RLC and Uu RLC).
7. Either U2N Relay UE or U2N Remote UE can initiate the PC5 unicast link release (PC5-S). The timing to execute link release is up to UE implementation. The U2N Relay UE can execute PC5 connection reconfiguration to release PC5 RLC for relaying upon reception of RRC Reconfiguration by gNB in Step 6, or the UE (i.e. previous U2N Remote UE) can execute PC5 connection reconfiguration to release PC5 RLC for relaying upon reception of RRC Reconfiguration by gNB in Step 3.
8. The data path is switched from indirect path to direct path between the UE (i.e. previous U2N Remote UE) and the gNB. Step 8 can be executed in parallel or after step 5, which is independent of step 6 and step 7. The DL/UL lossless delivery during the path switch is done according to PDCP data recovery procedure.

FIG. 4 illustrates a switching from direct to indirect path (remote UE switching to indirect relay UE):
1. The U2N Remote UE reports one or multiple candidate U2N Relay UE(s) and legacy Uu measurements, after it measures/discovers the candidate U2N Relay UE(s).
The UE may filter the appropriate U2N Relay UE(s) according to Relay selection criteria before reporting. The UE shall report only the U2N Relay UE candidate(s) that fulfil the higher layer criteria.
   The reporting can include at least U2N Relay UE ID, U2N Relay UE's serving cell ID, and SD-RSRP information.
2. The gNB decides to switch the U2N Remote UE to a target U2N Relay UE. Then the gNB sends an RRCReconfiguration message to the target U2N Relay UE, which can include at least Uu and PC5 RLC configuration for relaying, and bearer mapping configuration (at step 2, the gNB may decide to perform a normal handover rather than a path switch to an indirect path).
3. The gNB sends the RRCReconfiguration message to the U2N Remote UE. The contents in the RRCReconfiguration message can include at least U2N Relay UE ID, PC5 RLC configuration for relay traffic and the associated end-to-end radio bearer(s). The U2N Remote UE stops UP and CP transmission over Uu after reception of RRCReconfiguration message from the gNB.
4. The U2N Remote UE establishes PC5 connection with target U2N Relay UE
5. The U2N Remote UE completes the path switch procedure by sending the RRCReconfigurationComplete message to the gNB via the Relay UE.
6. The data path is switched from direct path to indirect path between the U2N Remote UE and the gNB.

Applying the above-described scenarios, connectivity interruptions may occur during paths changes due to the mobility of the UEs, or due poor channel conditions (e.g., coverage holes).

### SUMMARY

It is an objective of the present application to improve service continuity in sidelink multi-path link communication.

Thereto, multi-path scenarios are provided, wherein a wireless device or remote UE is connected to a cell established by a base station or gNB, wherein the remote UE performs the steps of:
maintaining a first and a second communication path, wherein each the first and the second communication path is either a direct path, where the communication is exchanged directly between the remote UE and the gNB, or an indirect path, wherein the communication is exchanged between the remote UE and the gNB via a relay UE;
determining that one of communication paths (the second path) becomes or will become unavailable; and
activating a third communication path, to replace the communication paths that becomes or will become unavailable.

In an embodiment, the first communication path is a direct path, wherein the second path is an indirect path involving a first relay UE, wherein the third communication path is an indirect communication path involving a second relay UE, and wherein determining that one of communication paths becomes or will become unavailable comprises detecting that the indirect path involving the first relay UE becomes or will become unavailable.

According to an embodiment, a wireless device and a method performed by the wireless device are provided, wherein the wireless device is acting as a relay UE that is connected to a cell established by a base station, gNB, wherein the UE performs the steps of:
maintaining a communication path, wherein the communication path is an indirect path for exchanging data traffic between a remote UE and the gNB via the UE; and
activating or deactivating the communication path in response to receiving a corresponding indication from the remote UE or the gNB.

According to an embodiment, a base station and a method performed by a base station, gNB, are provided to establishing a cell to connect to a wireless device, remote UE, wherein the gNB performs the steps of:
maintaining a first and a second communication path, wherein each the first and the second communication path is either a direct path, where the communication is exchanged directly between the remote UE and the gNB, or an indirect path, wherein the communication is exchanged between the remote UE and the gNB via a relay UE;
determining that one of communication paths becomes or will become unavailable; and
activating a third communication path, to replace the communication paths that becomes or will become unavailable.

Further embodiments refer to a remote UE, a relay UE and a gNB being configured to perform the respective methods described above. These and other objects, features and advantages of the present disclosure will become apparent upon reading the following Detailed Description in view of the Drawings briefly described below.

### BRIEF DESCRIPTION OF THE DRAWINGS

FIG. 1 shows a diagram that illustrates the protocol stack for user plane transport for a L2 UE-to-Network Relay UE.

FIG. 2 is a block diagram that illustrates the protocol stack of the non-access stratum (NAS) connection of the Remote UE to the NAS mobility management (NAS-MM) and NAS session management (NAS-SM) components.

FIG. 3 is a signalling diagram that illustrates operations for switching a Remote UE from an indirect path to a direct path.

FIG. 4 is a signalling diagram that illustrates operations for switching a Remote UE from a direct path to an indirect path.

FIG. 5 is a diagram illustrating a path change in a multi path scenario.

FIG. 6 is a flow diagram illustrating steps for a path change performed in a remote UE.

FIG. 7 is a flow diagram illustrating steps for a path change performed in base station.

FIG. 8 is a flow diagram illustrating steps for a path change performed in a relay UE.

FIG. 9 is an exemplary block diagram of a UE.

FIG. 10 is an exemplary block diagram of a RAN Node.

FIG. 11 is a schematic block diagram illustrating a telecommunication network connected via an intermediate network to a host computer.

FIG. 12 is a generalized block diagram of a host computer communicating via a base station with a user equipment over a partially wireless connection.

FIG. 13 is a flowchart depicting embodiments of a method in a communications system including a host computer, a base station and a user equipment.

FIG. 14 is a flowchart depicting embodiments of a method in a communications system including a host computer, a base station and a user equipment.

FIG. 15 is a flowchart depicting embodiments of a method in a communications system including a host computer, a base station and a user equipment.

FIG. 16 is a flowchart depicting embodiments of a method in a communications system including a host computer, a base station and a user equipment.

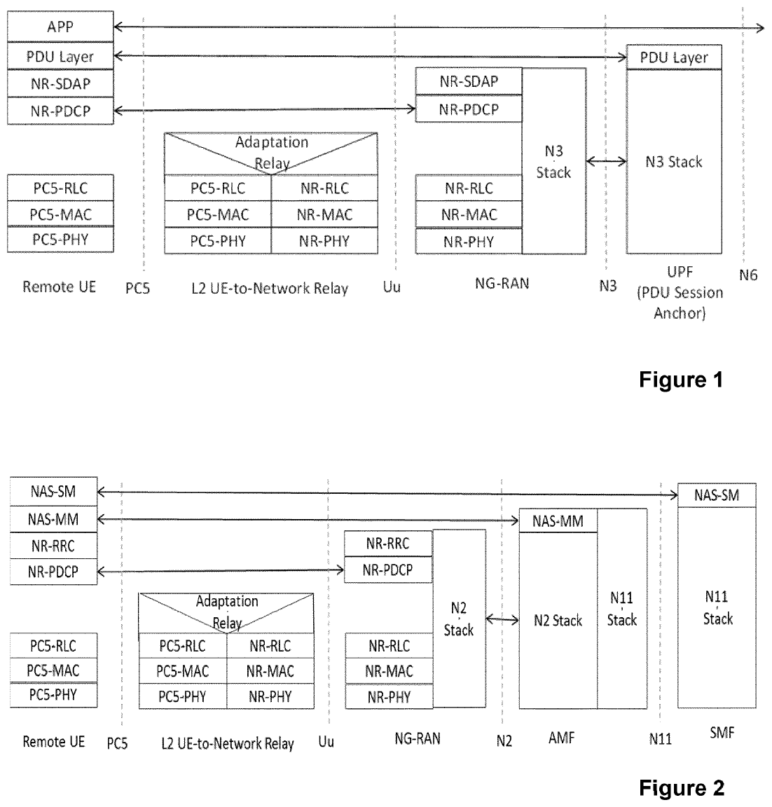

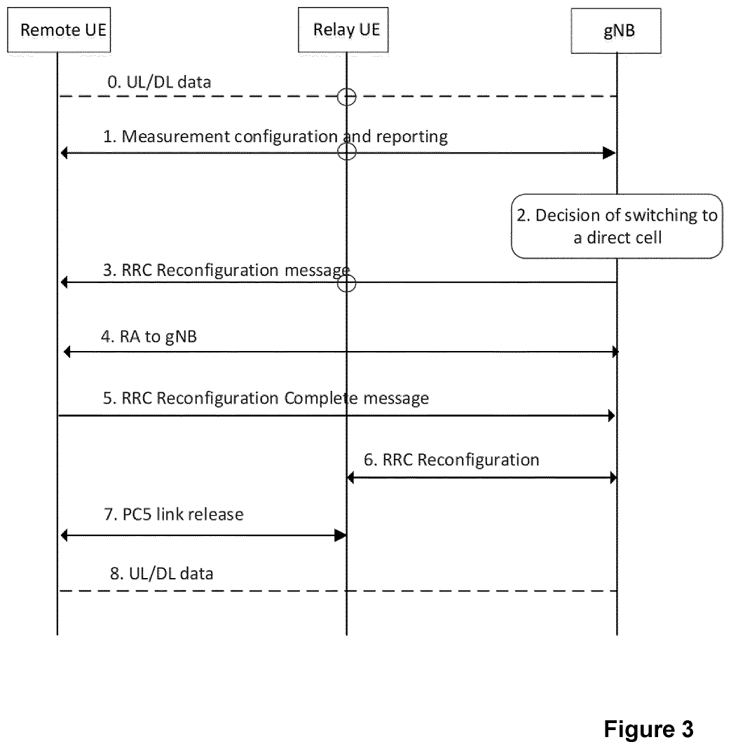

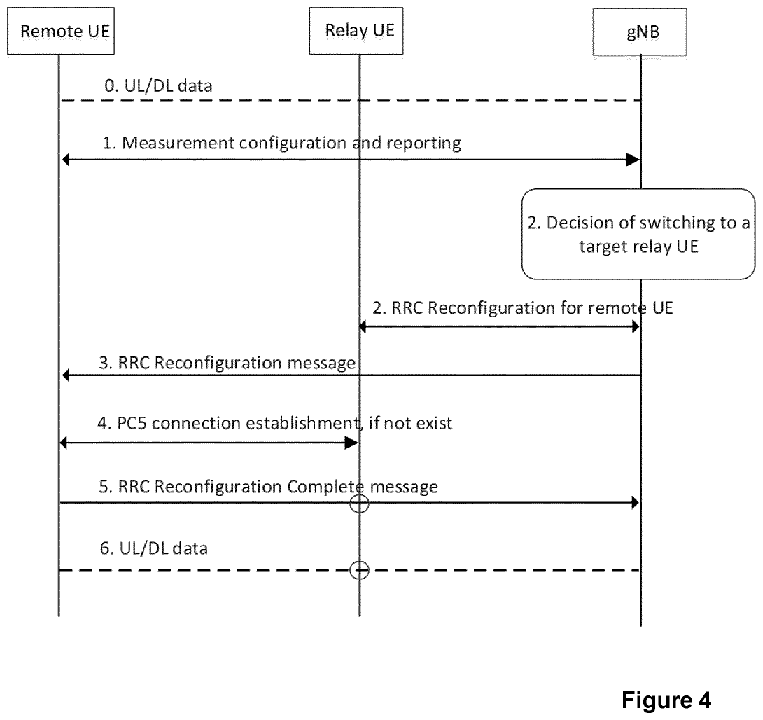

### DETAILED DESCRIPTION

In this specification the term “node” may be any a network node or user equipment (UE) or wireless device. Examples of network nodes are NodeB, base station (BS), multi-standard radio (MSR) radio node such as MSR BS, eNodeB, gNodeB. MeNB, SeNB, integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, RRU, RRH, nodes in distributed antenna system (DAS), core network node (e.g. MSC, MME etc), O&M, OSS, SON, positioning node (e.g. E-SMLC), etc.

The term UE refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, Tablet, mobile terminals, smart phone, laptop embedded equipment (LEE), laptop mounted equipment (LME), USB dongles etc.

The term “radio network node” or “network node” may be or may comprise a base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP etc.

The term radio access technology, or RAT, may refer e.g., to Universal Terrestrial Radio Access (UTRA), Evolved to Universal Terrestrial Radio Access (E-UTRA), narrow band internet of things (NB-IoT), WiFi, Bluetooth, next generation RAT, New Radio (NR), 4G, 5G, etc. Any of the equipment denoted by the terminology node, network node or radio network node may be capable of supporting a single or multiple RATs.

Further, in the following, the term “standalone sidelink” refers to a sidelink connection that is between a UE (source UE) and a peer UE (destination UE), and where the peer UE is the destination of the traffic. The term “sidelink relay” or “relay path” refers to a sidelink connection between a source UE (remote UE, RM UE) and a destination UE/gNB, where communication is directed via an intermediate UE (i.e., the relay UE, RL UE).

The term “direct path” refers to a direct connection from a remote UE to a gNB (e.g., via NR air interface) or a destination UE (e.g., via NR SL air interface); the term “indirect path” refers to an indirect connection between a remote UE and a gNB or another destination UE via an intermediate node, such as a relay UE or a relay gNB.

The term “primary path” refers to a path on which control plane signalling is sent. Control plane signalling may specifically comprise an exchange of RRC messages.

According to embodiments, control plane signalling may be only sent over the primary path, while data signalling (user plane or data plane signalling) may be sent over the direct path, indirect path, or both paths at the same time.

In the following, embodiments will be described that provide for service continuity and prevent connectivity interruptions in scenarios, where a remote UE in under the coverage of one cell that is established by a base station or gNB. The remote UE has two (or more) active paths (also being referred to as multi path) at the same time towards the network (base station); one direct path (over Uu) and one indirect path (over PC5) via a relay UE.

Due to mobility (e.g., due to a movement of the remote UE), or poor channel condition (e.g., due to coverage holes), one (indirect) path may become unavailable (or is about to become unavailable). This (old or current) path shall be exchanged with a new one (or in other words a path switch shall be performed from the old path to a new path.

If one of the paths gets unavailable the remote UE may switch its data transmission to the other path that is still available or active. This may be based on autonomous decision or on an indication/command received from the network.

Further, one or more of the following actions may be performed:
the remote UE sends a measurement report over the other path that is still active; this information may comprise a (new) set of possible candidate relay UEs;
the remote UE switches the sending of control plane messages over the path that is still active, the switching may be performed autonomously, upon an indication from the network, or upon an indication from the relay UE;
the remote UE may report a Radio Link Failure, RLF report/indication to the network indicative of a cause of unavailability of one of the paths; this report/indication may also comprise information about the involved relay UE (if the path that is not available is the indirect path).

If the remote UE determines that one of the paths is going to change e.g., because the relay UE announces to the remote UE that it is going out-of-coverage that is going to IDLE mode or INACTIVE mode, or that will not be available anymore, the remote UE may perform at least one of the following actions:
the remote UE sends an indication to the network to change the corresponding path;
the remote UE starts a discovery procedure to identify one or a plurality of candidate relay UEs, selects one of them as target relay UE, and then sends a corresponding indication to the network (comprising information that one of the paths needs to be changed and that the new path shall be directed over the selected target relay UE). Alternatively, the remote UE may send an indication to the network by including a list of candidate relay UEs such that the network may choose one of them as target relay UE;
the remote UE starts the discovery procedure to identify candidate relay UEs, selects one of them and establish a new path over the selected target relay UE. After the establishment, the remote UE may send an indication to the network to inform that a new path towards the new relay UE has been established (and that an old path towards the old relay UE shall be released).

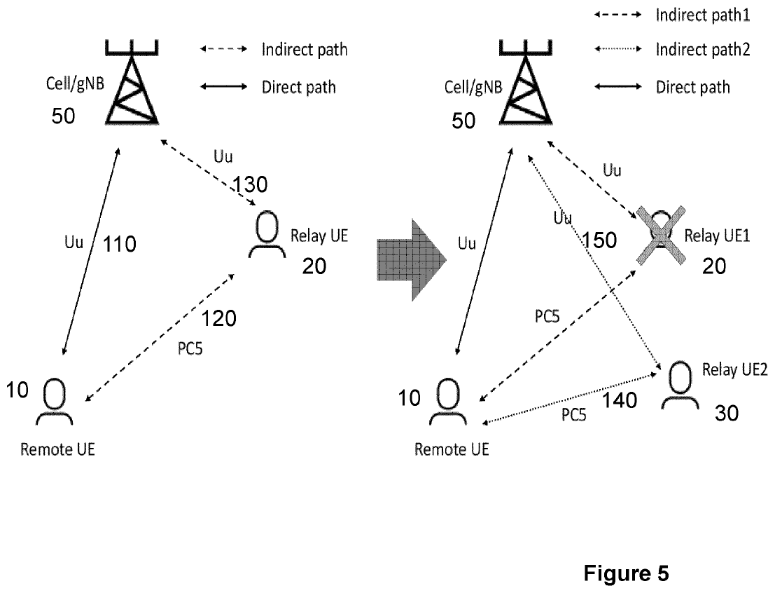

FIG. 5 illustrates a scenario, where remote UE 10 in under the coverage of one cell, wherein this cell may be established by gNB 50. Remote UE 10 has two active paths at the same time towards the network, one direct path 110 (Uu interface 110) and a first indirect path via a first relay UE 20, wherein the first indirect path comprises a first PC5 interface 120 between the remote UE 10 and the first relay UE 20 and a second Uu interface 130 between the first relay UE 20 and the gNB 50. Such situation is depicted on at the left side of FIG. 5. Due to mobility or bad channel condition, the first indirect path 120, 130 may become unavailable (or is about to becoming unavailable).

In order to provide for service continuity, the first indirect path shall be replaced by another indirect path. Thereto, the right hand side of FIG. 5 additionally shows a second relay UE 30 and a second indirect path via a second relay UE 30, wherein the second indirect path comprises a second PC5 interface 140 between the remote UE 10 and the second relay UE 30 and a third Uu interface 150 between the second relay UE 30 and the gNB 50. After the path switching, the remote UE 10 has again two paths being active at the same time, namely the first direct path 120 and the second indirect path 140, 150.

In particular, the network (gNB 50), upon receiving a measurement report from the remote UE 10, decides to configure more than one path at the remote UE 10. In particular, the network may configure one direct path over Uu that provides a direct connection between the remote UE and the network, and one or a plurality of indirect paths via a relay UEs 20, 30 that may provide further connections between the remote UE and the network.

In an embodiment, upon detecting that an active indirect path is/will not be available anymore, the remote UE 10 switches its transmissions (i.e., transmitting and receiving) over the direct path. The switching of the transmission from the indirect path to the direct path can be done autonomously, e.g., if the remote UE detects that the relay UE over the indirect path is not available anymore, or upon receiving an indication from the network (gNB 50) that the corresponding relay UE is not available anymore (e.g., as result of detecting radio link failure or of a handover of the relay UE) or because the remote UE has reported a corresponding indication to the network.

In a further embodiment, the remote UE 10 may determine that the indirect path is not available anymore after/as result of detecting a radio link failure (RLF) over the link (PC5 link) between the remote UE and relay UE, and/or receiving an indication from the network (gNB 50) about an unavailability of the relay UE.

The RLF detection may be performed according to one or a plurality of the following criteria:
a maximum number of RLC retransmissions is reached over the PC5 interface,
a maximum number of DTX transmissions is reached over the PC5 interface,
a reconfiguration failure over the PC5 interface,
an indication from the relay UE upon handover of cell (re)selection,
an inactivity of the indirect path for a certain amount of time (e.g., a timer is started every time there is a transmission or a reception of data over the indirect path),
an indication from the relay UE that a handover is performed or is about to be performed, and
an indication from the relay UE that a cell (re)selection procedure is performed or will be performed.

The indication may be one or a plurality of:
an indication from the network over the direct path about a radio link failure over the Uu link between the network and the relay UE,
an indication from the network over the direct path that a handover is performed or is about to be performed, and
an indication from the network over the direct path that a cell (re)selection procedure is performed or about to be performed.

In a further embodiment, in case the remote UE 10 identifies that the indirect path is going to be soon unavailable (e.g., because the relay UE is performing handover, is sent to RRC_IDLE/RRC_INACTIVE, or is going out-of-coverage of the cell), the remote UE may perform at least one of the following actions:
the remote UE sends an indication over the other path (e.g., the direct path) to the network comprising an information that the indirect path is going to be non-available soon, or it may comprise a request to the network to change the indirect path (e.g., the relay UE to be changed);
the remote UE starts a discovery procedure, identifies possible candidate relay UEs, selects one of them, and sends a corresponding information to the network (e.g., comprising an indication that one of the paths needs to be changed and that the new path should be configured according to the selected new (target) relay);
the remote UE starts the discovery procedure, identifies possible candidate relay UEs, and sends a corresponding indication to the network (e.g. comprising a list of candidate relay UEs discovered, such that the network may select one of candidate relay UE as target relay UE). The remote UE may receive from the network a signaling information comprising the configuration to be used to establish a new indirect path with the new target relay UE;
the remote UE starts the discovery procedure, identifies possible candidate relay UEs, selects one of them, and establishes already a PC5 connection to the network to set up the indirect path. After the PC5 connection with the relay UE has been established, the relay UE may inform the network, over its Uu connection, that the remote UE wants to establish an indirect path with this relay UE. Alternatively, after the PC5 connection with the relay UE has been established, the remote UE may send a signaling to the network for informing that a new relay UE has been selected and that the PC5 link has been already established (at this point, the network needs only to establish the Uu part of the indirect path). Further, the remote UE may (explicitly) indicate to the network that the old indirect path should be released and that a new indirect path should be established.

In a further embodiment, the network, when configuring the remote UE with multi-path communication (via an indirect path and a direct path), it sends to the remote UE a plurality of configurations to be stored. These configurations may be used to configure multiple indirect paths, wherein one (or more) of the configured plurality of indirect paths may be activated (switched to from a currently used indirect path) depending on the actual (radio) quality of the currently used indirect path. According to this, the network may decide to activate/deactivate an indirect path by only sending an activation/deactivation command to the remote UE; such decision may be based on determining that the currently active indirect path is or will become unavailable, has failed or will fail. This command may be sent via the direct path, via the indirect path, or both. In particular, the activation or deactivation command used by the network to activate or deactivate an indirect path may be a (new or existing) RRC message, a (new or existing) MAC CE, a control PDU of the adaptation later, a (new or existing) field in the sidelink control information (SCI), or a new SCI itself. The network may further indicate that the path over which the control plane signaling should be sent is/will be also switched onto the indirect path being activated, over the current indirect path (not yet being deactivated) or both.

In a further embodiment, the activation or deactivation command used by the network to activate or deactivate an indirect path may include information of which primary path to use once that a certain indirect path is activated. This may depend on the channel quality of the indirect path with respect to the channel quality of the direct path.

Alternatively, the remote UE, when receiving the activation or deactivation command from the network to activate or deactivate an indirect path, may decide autonomously to change the primary path (i.e., to switch the path on which the control plane signalling is exchanged). In this case, the remote UE may indicate that the primary path has been changed after a new indirect path has been activated and the network may send to the remote UE one of the following:
an indication to keep the primary path unchanged;
switch the control plane signalling to the new path (to change the primary path); and
an indication to send control plane signaling over both the indirect and direct path.

In a further embodiment, if the remote UE identifies (i.e., according to the previous embodiments) that the indirect path is (about to become) unavailable and, at the same time, a radio link failure is experienced on the direct path (basically both the direct and indirect path are not available), the remote UE performs the following actions:
trigger RRC reestablishment and start to look for a new cell;
trigger sidelink discovery procedure to identify new potential candidate relay UEs;
trigger relay UE (re)selection and cell (re)selection; and
initiate RACH over the new cell, or initiate relay transmission over the new relay UE.

In a further embodiment, which option the remote UE shall use is decided by the network and e.g. communicated to the remote UE via dedicated RRC signaling (e.g., via system information). As an alternatives, which option the UE shall use is decided by the relay UE or is pre-configured (at the remote UE).

In a further embodiment, for any of all above-described scenarios, one or a plurality of the following signaling may be applied:

For signaling between remote UE and the gNB:
RRC signaling;
MAC CE; and
L1 signaling on channels such as PRACH, PUCCH, PDCCH.

For signaling between remote UE and relay UE:
RRC signaling (e.g., PC5-RRC);
PC5-S signaling;
Discovery signaling;
MAC CE; and
L1 signaling on channels such as PSSCH, PSCCH, or PSFCH.

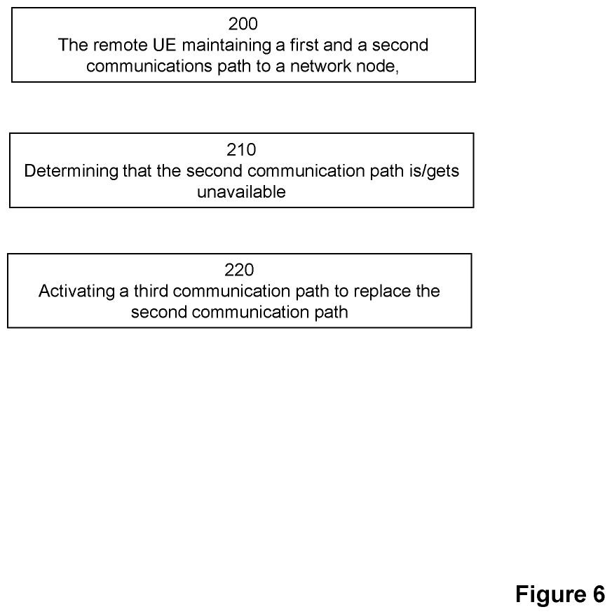

FIG. 6 is a flow diagram illustrating steps for a path change performed in remote UE 10. In accordance with the above-described embodiments, the remote UE performs the steps of:
Step 200: maintaining a first and a second communication path, wherein each the first and the second communication path is either a direct path, where the communication is exchanged directly between the UE and the gNB, or an indirect path, wherein the communication is exchanged between the UE and the gNB via a relay UE (20, 30);
Step 210: determining that one of communication paths (the second path) becomes or will become unavailable; and
Step 220: activating a third communication path, to replace the communication paths that becomes or will become unavailable.

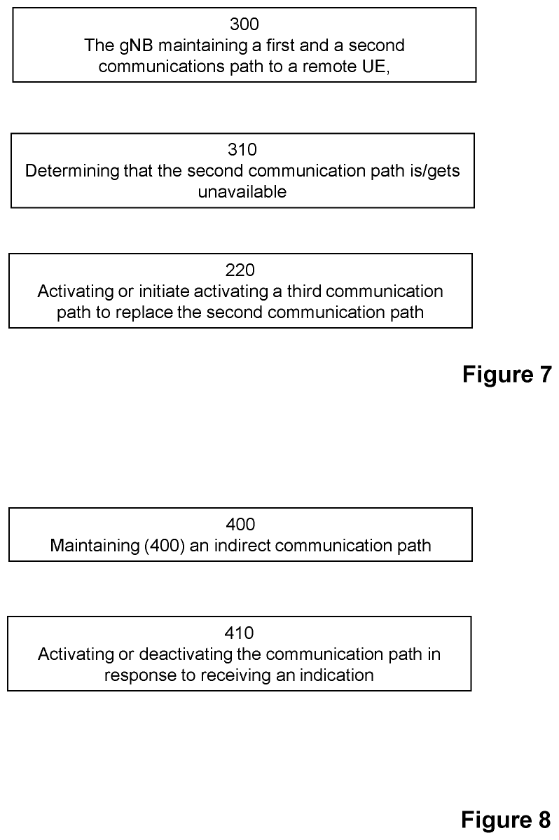

FIG. 7 is a flow diagram illustrating steps for a path change performed in base station or gNB 50. In accordance with the above-described embodiments, the gNB performs the steps of:
Step 300: maintaining a first and a second communication path, wherein each the first and the second communication path is either a direct path, where the communication is exchanged directly between the remote UE and the gNB, or an indirect path, wherein the communication is exchanged between the remote UE and the gNB via a relay UE (20, 30);
Step 310: determining that one of communication paths becomes or will become unavailable; and
Step 320: activating or in initiating to activate a third communication path, to replace the communication paths that becomes or will become unavailable.

FIG. 8 is a flow diagram illustrating steps for a path change performed in relay UE 20 or 30. In accordance with the above-described embodiments, the relay UE performs the steps of:
Step 400: maintaining a communication path, wherein the communication path is an indirect path for exchanging data traffic between a remote UE 10 and the gNB 50 via the UE (20, 30); and
Step 410: activating or deactivating the communication path in response to receiving a corresponding indication from the remote UE 10 or the gNB 50.

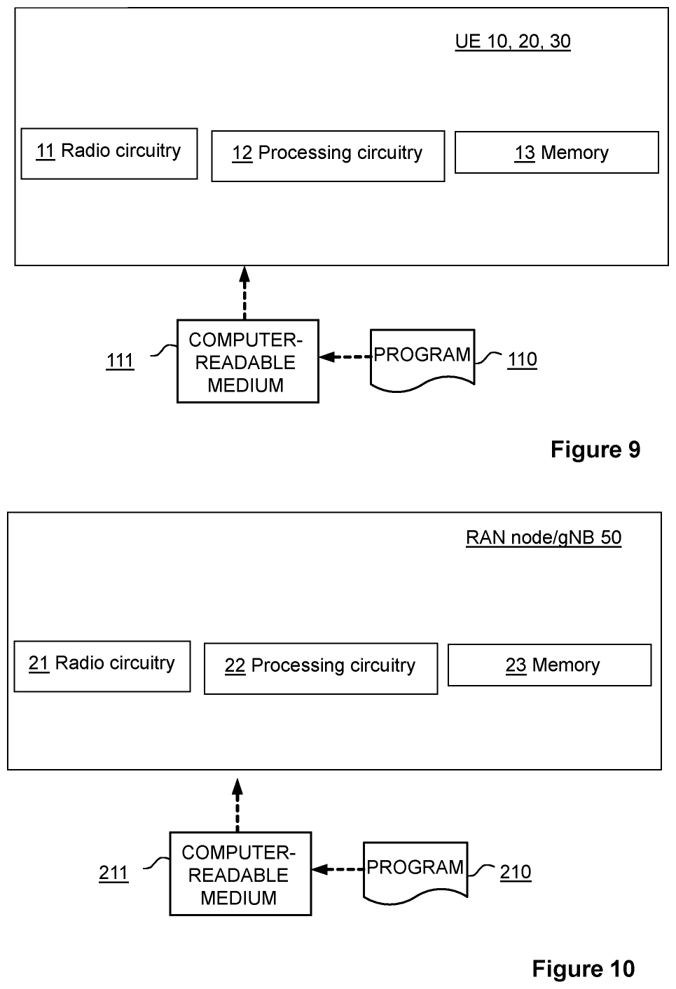

As illustrated in FIG. 9 the remote UE 10, the first relay UE 20 and/or the second relay UE 30 (in the following being referred to as UE) includes an antenna processing circuitry or radio circuitry 11, device-readable medium 11, processing circuitry 12 and memory 13. The UE further may comprise a user power source and power circuitry. The UE can include multiple sets of one or more of the illustrated components for different wireless technologies supported by UE, such as, for example, GSM, WCDMA, LTE, NR, WiFi, WiMAX, or Bluetooth wireless technologies, just to mention a few. These wireless technologies can be integrated into the same or different chips or set of chips as other components within the UE.

The UE further comprises an antenna that can include one or more antenna arrays, configured to send and/or receive wireless signals. In certain alternative embodiments, the antenna can be separate from the UE and be connectable to the UE through an interface or port.

Processing circuitry 12 can comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other UE components, such as device-readable medium 11, UE functionality. Such functionality can include providing any of the various wireless features or benefits discussed herein. For example, processing circuitry 12 can execute instructions stored in device-readable medium 111 or in memory 110 within processing circuitry 12 to provide the functionality disclosed herein.

Processing circuitry 12 can be configured to perform any determining, calculating, or similar operations (e.g., certain obtaining operations) described herein as being performed by the UE. These operations, as performed by processing circuitry 12, can include processing information obtained by processing circuitry 12 by, for example, converting the obtained information into other information, comparing the obtained information or converted information to information stored by the UE, and/or performing one or more operations based on the obtained information or converted information, and as a result of said processing making a determination.

FIG. 10 shows a block diagram of an exemplary RAN node or gNB 50, that may also be referred to as base station or satellite (node) according to various embodiments of the present disclosure, including those described above with reference to other figures. For example, exemplary RAN node 50 can be configured by execution of instructions, stored on a computer-readable medium, to perform operations corresponding to one or more of the exemplary methods described herein. In some exemplary embodiments, RAN node 50 can comprise a base station, eNB, gNB, or one or more components thereof. For example, RAN node 50 can be configured as a central unit (CU) and one or more distributed units (DUs) according to NR gNB architectures specified by 3GPP. More generally, the functionally of RAN node 50 can be distributed across various physical devices and/or functional units, modules, etc.

RAN node 50 can include processor 22 (also referred to as “processing circuitry”) that is operably connected to program memory 211 and data memory 210 via a data bus, which can include parallel address and data buses, serial ports, or other methods and/or structures known to those of ordinary skill in the art.

Program memory 211 can store software code, programs, and/or instructions that, when executed by processor 22, can configure and/or facilitate RAN node 20 to perform various operations, including operations corresponding to various exemplary methods described herein. As part of and/or in addition to such operations, program memory 211 can also include software code executed by processor 22 that can configure and/or facilitate RAN node 20 to communicate with one or more other UEs or RAN nodes using other protocols or protocol layers, such as one or more of the PHY, MAC, RLC, PDCP, and RRC layer protocols standardized by 3GPP for LTE, LTE-A, and/or NR, or any other higher-layer (e.g., NAS) protocols utilized in conjunction with radio circuitry 21 and/or core network interface 1050. Data memory 203 can comprise memory area for processor 202 to store variables used in protocols, configuration, control, and other functions of RAN node 200. As such, program memory 211 and data memory 23 can comprise non-volatile memory (e.g., flash memory, hard disk, etc.), volatile memory (e.g., static or dynamic RAM), network-based (e.g., “cloud”) storage, or a combination thereof. Processor 22 can include multiple individual processors (not shown), each of which implements a portion of the functionality described above.

Further embodiments:

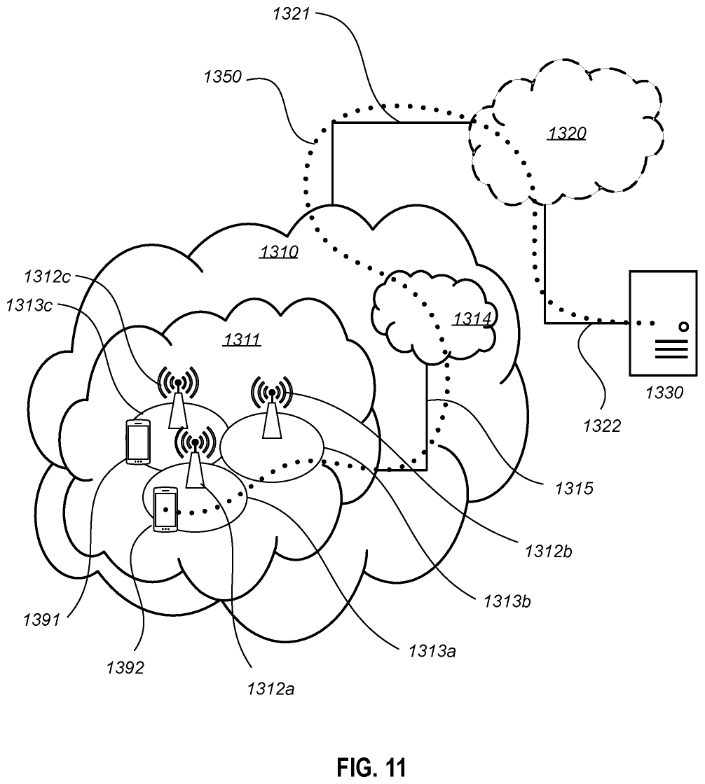

With reference to FIG. 11, a communication system includes telecommunication network 1310 such as the wireless communications network 100, for example, a 3GPP-type cellular network, which comprises access network 1311, such as a radio access network, and core network 1314. Access network 1311 comprises a plurality of network nodes such as any, or both, of the first node 111 and the second node 112. For example, base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to core network 1314 over a wired or wireless connection 1315. A plurality of user equipments, such as the user equipment 130 may be comprised in the wireless communications network 100. In FIG. 11, a first UE 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312. Any of the UEs 1391, 1392 may be considered examples of the user equipment 130.

Telecommunication network 1310 is itself connected to host computer 1330, which may be embodied in the hardware and/or software of a standalone server, a cloud-implemented server, a distributed server or as processing resources in a server farm. Host computer 1330 may be under the ownership or control of a service provider, or may be operated by the service provider or on behalf of the service provider. Connections 1321 and 1322 between telecommunication network 1310 and host computer 1330 may extend directly from core network 1314 to host computer 1330 or may go via an optional intermediate network 1320. Intermediate network 1320 may be one of, or a combination of more than one of, a public, private or hosted network; intermediate network 1320, if any, may be a backbone network or the Internet; in particular, intermediate network 1320 may comprise two or more sub-networks (not shown).

The communication system of FIG. 11 as a whole enables connectivity between the connected UEs 1391, 1392 and host computer 1330. The connectivity may be described as an over-the-top (OTT) connection 1350. Host computer 1330 and the connected UEs 1391, 1392 are configured to communicate data and/or signaling via OTT connection 1350, using access network 1311, core network 1314, any intermediate network 1320 and possible further infrastructure (not shown) as intermediaries. OTT connection 1350 may be transparent in the sense that the participating communication devices through which OTT connection 1350 passes are unaware of routing of uplink and downlink communications. For example, base station 1312 may not or need not be informed about the past routing of an incoming downlink communication with data originating from host computer 1330 to be forwarded (e.g., handed over) to a connected UE 1391. Similarly, base station 1312 need not be aware of the future routing of an outgoing uplink communication originating from the UE 1391 towards the host computer 1330.

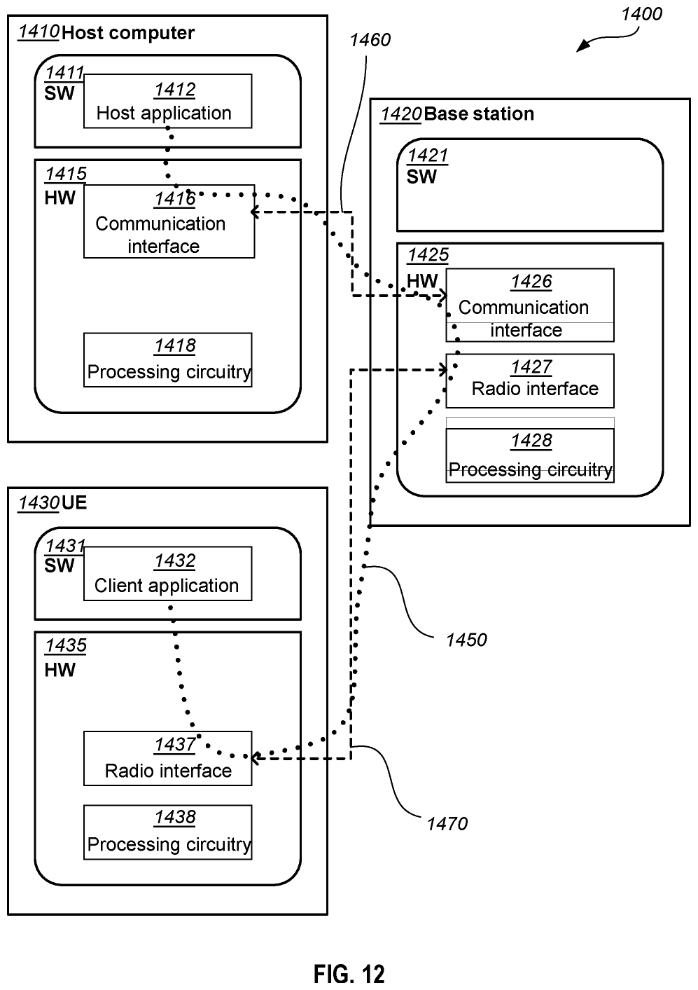

In relation to FIGS. 12, 13, 14, 15, and 16, which are described next, it may be understood that a UE is an example of the user equipment 130, and that any description provided for the UE equally applies to the user equipment 130. It may be also understood that the base station may be considered an example of any, or both, of the first node 111 and the second node 112, and that any description provided for the base station equally applies to any, or both, of the first node 111 and the second node 112.

Example implementations, in accordance with an embodiment, of the user equipment 130, e.g., a UE, and any, or both, of the first node 111 and the second node 112, e.g., a base station and host computer discussed in the preceding paragraphs will now be described with reference to FIG. 12. In communication system 1400, such as the wireless communications network 100, host computer 1410 comprises hardware 1415 including communication interface 1416 configured to set up and maintain a wired or wireless connection with an interface of a different communication device of communication system 1400. Host computer 1410 further comprises processing circuitry 1418, which may have storage and/or processing capabilities. In particular, processing circuitry 1418 may comprise one or more programmable processors, application-specific integrated circuits, field programmable gate arrays or combinations of these (not shown) adapted to execute instructions. Host computer 1410 further comprises software 1411, which is stored in or accessible by host computer 1410 and executable by processing circuitry 1418. Software 1411 includes host application 1412. Host application 1412 may be operable to provide a service to a remote user, such as UE 1430 connecting via OTT connection 1450 terminating at UE 1430 and host computer 1410. In providing the service to the remote user, host application 1412 may provide user data which is transmitted using OTT connection 1450.

Communication system 1400 further includes any, or both, of the first node 111 and the second node 112, exemplified in FIG. 12 as a base station 1420 provided in a telecommunication system and comprising hardware 1425 enabling it to communicate with host computer 1410 and with UE 1430. Hardware 1425 may include communication interface 1426 for setting up and maintaining a wired or wireless connection with an interface of a different communication device of communication system 1400, as well as radio interface 1427 for setting up and maintaining at least wireless connection 1470 with the user equipment 130, exemplified in FIG. 12 as a UE 1430 located in a coverage area (not shown in FIG. 12) served by base station 1420. Communication interface 1426 may be configured to facilitate connection 1460 to host computer 1410. Connection 1460 may be direct or it may pass through a core network (not shown in FIG. 12) of the telecommunication system and/or through one or more intermediate networks outside the telecommunication system. In the embodiment shown, hardware 1425 of base station 1420 further includes processing circuitry 1428, which may comprise one or more programmable processors, application-specific integrated circuits, field programmable gate arrays or combinations of these (not shown) adapted to execute instructions. Base station 1420 further has software 1421 stored internally or accessible via an external connection.

Communication system 1400 further includes UE 1430 already referred to. Its hardware 1435 may include radio interface 1437 configured to set up and maintain wireless connection 1470 with a base station serving a coverage area in which UE 1430 is currently located. Hardware 1435 of UE 1430 further includes processing circuitry 1438, which may comprise one or more programmable processors, application-specific integrated circuits, field programmable gate arrays or combinations of these (not shown) adapted to execute instructions. UE 1430 further comprises software 1431, which is stored in or accessible by UE 1430 and executable by processing circuitry 1438. Software 1431 includes client application 1432. Client application 1432 may be operable to provide a service to a human or non-human user via UE 1430, with the support of host computer 1410. In host computer 1410, an executing host application 1412 may communicate with the executing client application 1432 via OTT connection 1450 terminating at UE 1430 and host computer 1410. In providing the service to the user, client application 1432 may receive request data from host application 1412 and provide user data in response to the request data. OTT connection 1450 may transfer both the request data and the user data. Client application 1432 may interact with the user to generate the user data that it provides.

It is noted that host computer 1410, base station 1420 and UE 1430 illustrated in FIG. 12 may be similar or identical to host computer 1330, one of base stations 1312a, 1312b, 1312c and one of UEs 1391, 1392 of FIG. 11, respectively. This is to say, the inner workings of these entities may be as shown in FIG. 12 and independently, the surrounding network topology may be that of FIG. 11.

In FIG. 12, OTT connection 1450 has been drawn abstractly to illustrate the communication between host computer 1410 and UE 1430 via base station 1420, without explicit reference to any intermediary devices and the precise routing of messages via these devices. Network infrastructure may determine the routing, which it may be configured to hide from UE 1430 or from the service provider operating host computer 1410, or both. While OTT connection 1450 is active, the network infrastructure may further take decisions by which it dynamically changes the routing (e.g., on the basis of load balancing consideration or reconfiguration of the network).

Wireless connection 1470 between UE 1430 and base station 1420 is in accordance with the teachings of the embodiments described throughout this disclosure. One or more of the various embodiments improve the performance of OTT services provided to UE 1430 using OTT connection 1450, in which wireless connection 1470 forms the last segment. More precisely, the teachings of these embodiments may improve the latency, signalling overhead, and service interruption and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 1450 between host computer 1410 and UE 1430, in response to variations in the measurement results. The measurement procedure and/or the network functionality for reconfiguring OTT connection 1450 may be implemented in software 1411 and hardware 1415 of host computer 1410 or in software 1431 and hardware 1435 of UE 1430, or both. In embodiments, sensors (not shown) may be deployed in or in association with communication devices through which OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of OTT connection 1450 may include message format, retransmission settings, preferred routing etc.; the reconfiguring need not affect base station 1420, and it may be unknown or imperceptible to base station 1420. Such procedures and functionalities may be known and practiced in the art. In certain embodiments, measurements may involve proprietary UE signaling facilitating host computer 1410's measurements of throughput, propagation times, latency and the like. The measurements may be implemented in that software 1411 and 1431 causes messages to be transmitted, in particular empty or ‘dummy’ messages, using OTT connection 1450 while it monitors propagation times, errors etc.

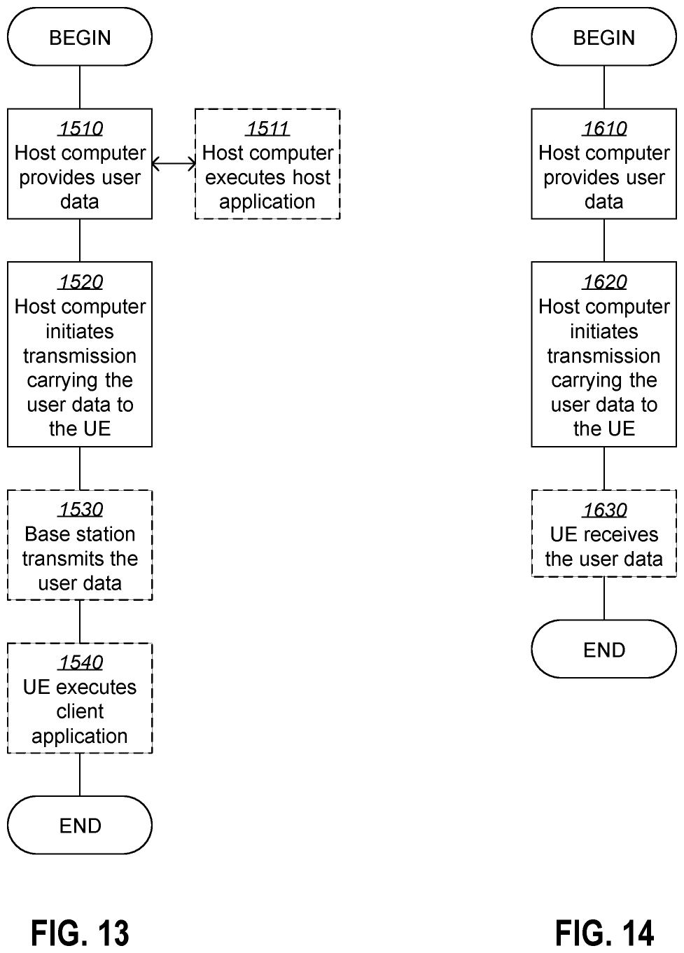

FIG. 13 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 13 will be included in this section. In step 1510, the host computer provides user data. In substep 1511 (which may be optional) of step 1510, the host computer provides the user data by executing a host application. In step 1520, the host computer initiates a transmission carrying the user data to the UE. In step 1530 (which may be optional), the base station transmits to the UE the user data which was carried in the transmission that the host computer initiated, in accordance with the teachings of the embodiments described throughout this disclosure. In step 1540 (which may also be optional), the UE executes a client application associated with the host application executed by the host computer.

FIG. 14 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 14 will be included in this section. In step 1610 of the method, the host computer provides user data. In an optional substep (not shown) the host computer provides the user data by executing a host application. In step 1620, the host computer initiates a transmission carrying the user data to the UE. The transmission may pass via the base station, in accordance with the teachings of the embodiments described throughout this disclosure. In step 1630 (which may be optional), the UE receives the user data carried in the transmission.

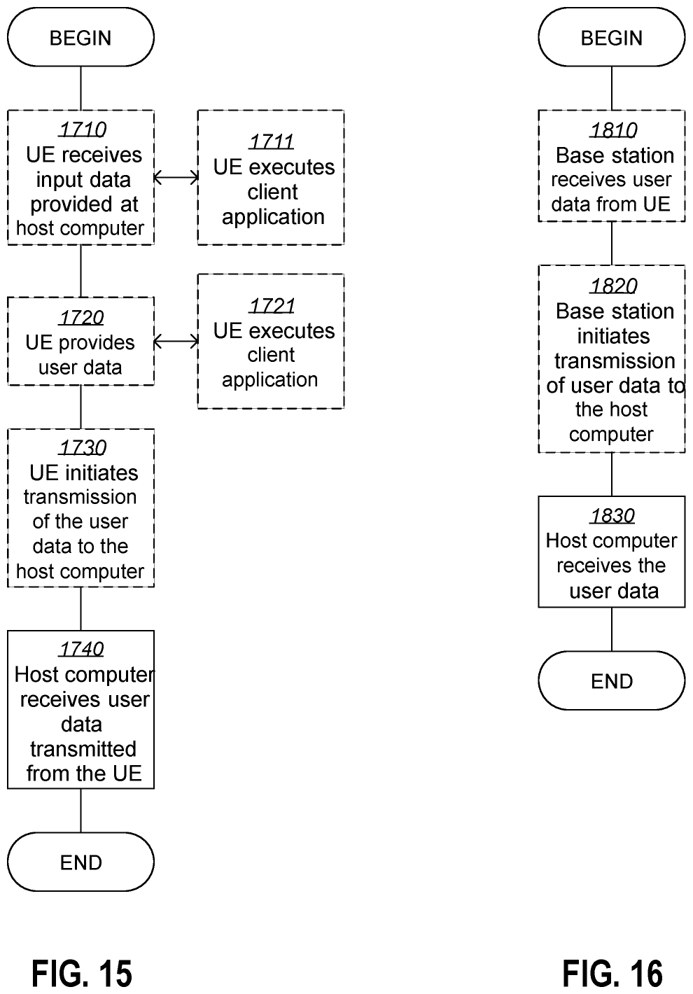

FIG. 15 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 15 will be included in this section. In step 1710 (which may be optional), the UE receives input data provided by the host computer. Additionally or alternatively, in step 1720, the UE provides user data. In substep 1721 (which may be optional) of step 1720, the UE provides the user data by executing a client application. In substep 1711 (which may be optional) of step 1710, the UE executes a client application which provides the user data in reaction to the received input data provided by the host computer. In providing the user data, the executed client application may further consider user input received from the user. Regardless of the specific manner in which the user data was provided, the UE initiates, in substep 1730 (which may be optional), transmission of the user data to the host computer. In step 1740 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 16 will be included in this section. In step 1810 (which may be optional), in accordance with the teachings of the embodiments described throughout this disclosure, the base station receives user data from the UE. In step 1820 (which may be optional), the base station initiates transmission of the received user data to the host computer. In step 1830 (which may be optional), the host computer receives the user data carried in the transmission initiated by the base station. In the following, a list of further embodiments is provided:
1. A method, performed by a wireless device, UE (10), wherein the UE (10) is connected to a cell established by a base station, gNB (50), wherein the UE performs the steps of:
   maintaining (200) a first and a second communication path, wherein each the first and the second communication path is either a direct path, where the communication is exchanged directly between the UE and the gNB, or an indirect path, wherein the communication is exchanged between the UE and the gNB via a relay UE (20, 30);
   determining (210) that one of communication paths (the second path) becomes or will become unavailable; and
   activating (220) a third communication path, to replace the communication paths that becomes or will become unavailable.
2. The method of Embodiment 1, wherein the first communication path is a direct path, wherein the second path is an indirect path involving a first relay UE (20), wherein the third communication path is an indirect communication path involving a second relay UE (30), and wherein determining (210) that one of communication paths becomes or will become unavailable comprises detecting that the indirect path involving the first relay UE (20) becomes or will become unavailable.
3. The method of Embodiment 1 or 2, wherein in response to detecting that one of communication paths becomes or will become unavailable, switching control plane signalling (e.g., RRC signalling) to the path that is still available or active.
4. The method of Embodiment 3, wherein the switching is performed in response to one of:
   an autonomous detection;
   receiving an indication/command from the gNB (50);
   receiving an indication from the first relay UE (20).
5. The method of Embodiment 4, wherein UE receives from the firs relay UE the indication that the first relay UE is
   going out of cell coverage;
   going to IDLE mode or to INACTIVE mode, or
   going to be unavailable.
6. The method of Embodiment 1-5, wherein, in response to determining that one of communication paths becomes or will become unavailable, sending an indication to the gNB to exchange the corresponding paths (switching from the communication paths that becomes or will become unavailable to the third communication path).
7. The method of Embodiment 1-6, wherein the UE sends a Radio Link Failure, RLF report to the gNB indicative of a cause of the unavailability of one of the paths.
8. The method of Embodiments 7, wherein the report comprises information about the relay UE involved in the path being or becoming unavailable.
9. The method of Embodiments 1-8, wherein UE (10) sends a measurement report to the gNB (50), the measurement report comprising an indication of one or a plurality of candidate relay UEs.
10. The method of Embodiments 1-8, wherein the UE initiates a discovery procedure to identify one or a plurality of candidate relay UEs, selects one of them as target relay UE to establish the third communication path, and sends a corresponding indication to the gNB.
11. The method of Embodiment 10, wherein the indication comprises one of:
   information that one of the paths needs to be changed and that the third communication path shall be directed over the selected target relay UE;
   information including a list of candidate target relay UEs such that the gNB may select one of them as target relay UE to establish the third communication path.
12. The method of the preceding Embodiment 7, wherein a RLF detection is performed according to one or a plurality of the following criteria:
   a maximum number of retransmissions is reached over the interface to the first relay UE,
   a maximum number of DTX transmissions is reached over the interface to the first relay UE,
   a reconfiguration failure over the interface to the first relay UE,
   an indication from the first relay UE upon handover of cell (re)selection,
   an inactivity of the path for a certain amount of time (e.g., a timer is started every time there is a transmission or a reception of data over the indirect path),
   an indication from the first relay UE that a handover is performed or is about to be performed, and
   an indication from the first relay UE that a cell (re)selection procedure is performed or will be performed.
13. The method of the Embodiment 4, wherein the indication/command from the gNB (50) or the indication from the first relay UE (20) comprises one of:
   an indication about a radio link failure of the interface between the gNB (50) and the first relay UE (20);
   an indication that a handover is performed or is about to be performed with respect to the first relay UE (20); and
   an indication that a cell (re)selection procedure is performed or about to be performed with respect to the first relay UE (20).
14. A method, performed by a wireless device, UE (20, 30), acting as a relay UE, wherein the UE (20, 30) is connected to a cell established by a base station, gNB (50), wherein the UE performs the steps of:
   maintaining (400) a communication path, wherein the communication path is an indirect path for exchanging data traffic between a remote UE (10) and the gNB (50) via the UE (20, 30); and
   activating or deactivating (410) the communication path in response to receiving a corresponding indication from the remote UE (10) or the gNB (50).
15. A method, performed by a base station, gNB (50) establishing a cell to connect to a wireless device, remote UE (10), wherein the gNB (50) performs the steps of:
   maintaining (300) a first and a second communication path, wherein each the first and the second communication path is either a direct path, where the communication is exchanged directly between the remote UE and the gNB, or an indirect path, wherein the communication is exchanged between the remote UE and the gNB via a relay UE (20, 30);
   determining (310) that one of communication paths becomes or will become unavailable; and
   activating (320) or initiating an activation of a third communication path, to replace the communication paths that becomes or will become unavailable.
16. The method of Embodiment 15, wherein the first communication path is a direct path, wherein the second path is an indirect path involving a first relay UE (20), wherein the third communication path is an indirect communication path involving a second relay UE (30), and wherein determining (310) that one of communication paths becomes or will become unavailable comprises detecting that the indirect path involving the first relay UE (20) becomes or will become unavailable.
17. The method of Embodiment 15 or 16, wherein in response to detecting that one of communication paths becomes or will become unavailable, initiating (e.g., by sending a corresponding command) switching in the remote UE (20) control plane signalling (e.g., RRC signalling) to the path that is still available or active.
18. The method of Embodiment 15-17, comprising receiving an indication from the remote UE to exchange the corresponding paths (switching from the communication paths that becomes or will become unavailable to the third communication path).
19. The method of Embodiment 15-18, comprising receiving a Radio Link Failure, RLF report from the remote UE indicative of a cause of the unavailability of one of the paths.
20. The method of Embodiments 19, wherein the report comprises information about the relay UE involved in the path being or becoming unavailable.
21. The method of Embodiments 15-20, further comprising receiving from the remote UE a measurement report, the measurement report comprising an indication of one or a plurality of candidate relay UEs.
22. The method of Embodiments 15-21, further comprising receiving from the remote UE an indication about a selection of a target relay UE to be involved in the establishment of the third communication path.
23. The method of Embodiments 15-21, comprising receiving information including a list of candidate target relay UEs, and selecting one of them as target relay UE to establish the third communication path.
24. The method of the Embodiment 18, wherein the indication/command comprises one of:
   an indication about a radio link failure of the interface between the gNB (50) and the first relay UE (20);
   an indication that a handover is performed or is about to be performed with respect to the first relay UE (20); and
   an indication that a cell (re)selection procedure is performed or about to be performed with respect to the first relay UE (20).
25. The method of Embodiments 15-18, further comprising configuring the remote UE (10) with a plurality of indirect paths, activating the third communication path by sending an activation command and/or deactivating the second communication path by sending a deactivation command, wherein the activation/deactivation command is sent in response to an actual radio quality of second communication path.
26. The method of Embodiment 25, wherein the activation/deactivation command is sent if the radio quality (e.g., a Signal Received Power or a Received Signal Strength) is below a certain level.
27. A wireless device, UE (10, 20, 30), the UE comprising:
   a transceiver,
   a processor connected to the transceiver; and
   a memory connected to the processor, wherein the memory comprises computer readable instructions that, when executed by the processor, cause the communication device to perform operations according to any of Embodiments 1-14.
28. A wireless device, UE (10), the UE being configured to perform the steps of Embodiments 1-14.
29. A non-transitory, computer-readable medium storing computer-executable instructions that, when executed by processing circuitry of a UE, configure the UE to perform operations corresponding to any of the methods of Embodiments 1-15.
30. A computer program product comprising computer-executable instructions that, when executed by processing circuitry of a wireless device, configure the wireless device to perform operations corresponding to any of the methods of Embodiments 1-15.
31. A Radio Access Network, RAN node or gNB (50), the gNB comprising:
   a transceiver,
   a processor connected to the transceiver; and
   a memory connected to the processor, wherein the memory comprises computer readable instructions that, when executed by the processor, cause the communication device to perform operations according to any of Embodiments 15-26.
32. A non-transitory, computer-readable medium storing computer-executable instructions that, when executed by processing circuitry of a UE, configure the UE to perform operations corresponding to any of the methods of Embodiments 1-15.
33. A computer program product comprising computer-executable instructions that, when executed by processing circuitry of a wireless device, configure the wireless device to perform operations corresponding to any of the methods of Embodiments 1-15.
34. A Radio Access Network, RAN node or gNB (50), the gNB being configured to perform any of the steps of Embodiments 15-26.

1. A method, performed by a wireless device, remote UE, wherein the remote UE is connected to a cell established by a base station, gNB, wherein the method performed by the remote UE comprises:
maintaining a first and a second communication path, wherein each the first and the second communication path is either a direct path, where the communication is exchanged directly between the remote UE and the gNB, or an indirect path, wherein the communication is exchanged between the remote UE and the gNB via a relay UE;
determining that one of the communication paths becomes or will become unavailable; and
activating a third communication path, to replace the one of the communication paths that becomes or will become unavailable.

2. The method of claim 1, wherein the first communication path is a direct path, wherein the second communication path is an indirect path involving a first relay UE, wherein the third communication path is an indirect communication path involving a second relay UE, and wherein determining that one of the communication paths becomes or will become unavailable comprises detecting that the indirect path involving the first relay UE becomes or will become unavailable.

3. The method of claim 1, wherein in response to determining that one of communication paths becomes or will become unavailable, switching control plane signalling to the path that is still available or active.

4. The method of claim 3, wherein the switching is performed in response to one of:
an autonomous detection;
receiving an indication/or command from the gNB; or
receiving an indication from the first relay UE.

5. The method of claim 4, wherein the remote UE receives from the first relay UE the indication that the first relay UE is:
going out of cell coverage;
going to IDLE mode or to INACTIVE mode; or
going to be unavailable.

6. The method of claim 1, wherein, in response to determining that one of the communication paths becomes or will become unavailable, sending an indication to the gNB to exchange the corresponding paths.

7. The method of claim 1, wherein the remote UE sends a Radio Link Failure, RLF report to the gNB indicative of a cause of the unavailability of one of the paths.

8. The method of claim 7, wherein the report comprises information about the relay UE involved in the path being or becoming unavailable.

9. The method of claim 8, wherein the remote UE sends a measurement report to the gNB, the measurement report comprising an indication of one or a plurality of candidate relay UEs.

10. The method of claim 8, wherein the remote UE initiates a discovery procedure to identify one or a plurality of candidate relay UEs, selects one of them as target relay UE to establish the third communication path, and sends a corresponding indication to the gNB.

11. The method of claim 10, wherein the indication comprises one of:
information that one of the paths needs to be changed and that the third communication path shall be directed over the selected target relay UE; or
information including a list of candidate target relay UEs such that the gNB may select one of them as target relay UE to establish the third communication path.

12. The method of claim 7, wherein a RLF detection is performed according to one or a plurality of the following criteria:
a maximum number of retransmissions is reached over the interface to the first relay UE,
a maximum number of DTX transmissions is reached over the interface to the first relay UE,
a reconfiguration failure over the interface to the first relay UE,
an indication from the first relay UE upon handover of cell (re)selection,
an inactivity of the path for a certain amount of time,
an indication from the first relay UE that a handover is performed or is about to be performed, and
an indication from the first relay UE that a cell (re)selection procedure is performed or will be performed.

13. The method of claim 4, wherein the indication/command from the gNB or the indication from the first relay UE comprises one of:
an indication about a radio link failure of the interface between the gNB and the first relay UE;
an indication that a handover is performed or is about to be performed with respect to the first relay UE; or
an indication that a cell (re)selection procedure is performed or about to be performed with respect to the first relay UE.

14. A method, performed by a wireless device, UE, acting as a relay UE, wherein the UE is connected to a cell established by a base station, gNB, wherein the method performed by the UE comprises:
maintaining a communication path, wherein the communication path is an indirect path for exchanging data traffic between a remote UE and the gNB via the UE; and
activating or deactivating the communication path in response to receiving a corresponding indication from the remote UE or the gNB.

15. A method, performed by a base station, gNB establishing a cell to connect to a wireless device, remote UE, wherein the method performed by the gNB comprises:
maintaining a first and a second communication path, wherein each the first and the second communication path is either a direct path, where the communication is exchanged directly between the remote UE and the gNB, or an indirect path, where the communication is exchanged between the remote UE and the gNB via a relay UE;
determining that one of the communication paths becomes or will become unavailable; and
activating or initiating an activation of a third communication path, to replace the communication paths that becomes or will become unavailable.

16. The method of claim 15, wherein the first communication path is a direct path, wherein the second communication path is an indirect path involving a first relay UE, wherein the third communication path is an indirect communication path involving a second relay UE, and wherein determining that one of the communication paths becomes or will become unavailable comprises detecting that the indirect path involving the first relay UE becomes or will become unavailable.

17. The method of claim 15, wherein in response to determining that one of the communication paths becomes or will become unavailable, initiating switching in the remote UE control plane signalling to the path that is still available or active.

18. The method of claim 15, comprising receiving an indication from the remote UE to exchange the corresponding paths.

19. The method of claim 18, wherein the indication comprises one of:
an indication about a radio link failure of the interface between the gNB and the first relay UE;
an indication that a handover is performed or is about to be performed with respect to the first relay UE; or
an indication that a cell (re)selection procedure is performed or about to be performed with respect to the first relay UE.

20. The method of claim 15, further comprising configuring the remote UE with a plurality of indirect paths, activating the third communication path by sending an activation command and/or deactivating the second communication path by sending a deactivation command, wherein the activation/deactivation command is sent in response to an actual radio quality of second communication path.

21-26. (canceled)

27. A wireless device, UE, the UE comprising:
a transceiver;
processing circuitry connected to the transceiver; and
a memory connected to the processing circuitry, wherein the memory comprises computer readable instructions that, when executed by the processing circuitry, cause the wireless device to;
maintain a first and a second communication path, wherein each the first and the second communication path is either a direct path, where the communication is exchanged directly between the remote UE and the gNB, or an indirect path, where the communication is exchanged between the remote UE and the gNB via a relay UE;
determine that one of the communication paths becomes or will become unavailable; and
activate a third communication path, to replace the communication paths that becomes or will become unavailable.

28-34. (canceled)

35. A wireless device, UE, the UE comprising:
a transceiver,
processing circuitry connected to the transceiver; and
a memory connected to the processing circuitry, wherein the memory comprises computer readable instructions that, when executed by the processing circuitry, cause the wireless device to:
maintain a communication path, wherein the communication path is an indirect path for exchanging data traffic between a remote UE and the gNB via the UE; and
activate or deactivate the communication path in response to receiving a corresponding indication from the remote UE or the gNB.
